(19) United States
(12) Patent Application Publication
(10) Pub. No.: US 2015/0135277 A1
(43) Pub. Date: May 14, 2015

(54) Methods for Generating and Using Trust Blueprints in Security Architectures

(71) Applicant: Futurewei Technologies, Inc., Plano, TX (US)

(72) Inventors: Deepak K. Vij, San Jose, CA (US); Ishita Majumdar, Milpitas, CA (US); Naveen Dhar, San Jose, CA (US)

(21) Appl. No.: 14/539,732

(22) Filed: Nov. 12, 2014

Related U.S. Application Data
(60) Provisional application No. 61/903,810, filed on Nov. 13, 2013.

(51) Int. Cl. H04L 29/06

(52) U.S. Cl. CPC H04L 63/0892; H04L 63/10
USPC 726/4

(57) ABSTRACT

Reputation-based trust attributes provided by network devices can be used by a truster device to gauge the trust-worthiness of a trustee device. The reputation-based attributes gathered from network devices may indicate a level of trust between those network devices and a trustee device. The truster device may then use those reputation-based attributes to determine a trust level between the truster device and the trustee device without relying on a dedicated authenticator, such as an authorization, authentication, and accounting (AAA) server. The truster device may permit the trustee device to access (or provide) a service when the determined trust level exceeds a threshold associated with that service. Reputation-based attributes may be exchanged between peers of a federated network or federated trust domain. Reputation-based attributes may also be exchanged between brokers in different federated networks/trust-domains.

This patent application claims priority to U.S. Provisional Application No. 61/903,810, filed on Nov. 13, 2013 and entitled “Methods for Generating and Using Trust Blueprints in Security Architectures,” which is hereby incorporated by reference herein as if reproduced in its entirety.

### TECHNICAL FIELD

The present invention relates to telecommunications, and, in particular embodiments, to methods for generating and using trust blueprints in security architectures.

### BACKGROUND

In telecommunications and other technologies, it is often desirable to provide security architectures for establishing trust relationships between two entities such that one entity (e.g., a “truster”) trusts another entity (e.g., a “trustee”). Traditional security architectures regulate access to resources/services through the granting of authorization rights by a centralized authenticator (e.g., a “trustee”). A centralized authenticator is a device that has the ability to unilaterally establish a trust relationship between other devices in a federated trust domain, such as an authorization, authentication, and accounting (AAA) server. Centralized security architectures may be ill-suited for some contemporary networks. For example, centralized authenticators may lack the flexibility, granularity, and extensibility to make efficient and informed security decisions in highly distributed networks and/or heterogeneous cloud computing networks. Accordingly, security architectures capable of providing efficient trust mechanisms in highly distributed open network environments are desired.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of a system for establishing dynamic trust between client and a server;

FIG. 2 illustrates a diagram of a network for establishing a trust relationship between a truster and a trustee;

FIG. 3 illustrates a diagram of an embodiment network architecture for exchanging reputation-based attributes within a federated trust domain;

FIG. 4 illustrates a diagram of an embodiment network architecture for exchanging reputation-based attributes between different federated trust domains;

FIG. 5 illustrates a diagram of an embodiment point-to-point (P2P) trust management topology;

FIG. 6 illustrates a diagram of how trust contexts can apply to various situations;

FIG. 7 illustrates a diagram of an embodiment Trust Management System;

FIG. 8 illustrates a diagram of an extensible access control markup language (XACML) compliant policy management system;

FIG. 9 illustrates a diagram of an embodiment trust based assignment process;

FIG. 10 illustrates a diagram of a trust management conceptual layered architecture;

FIG. 11 illustrates a diagram of a trust aware federated identity management network;

FIG. 12 illustrates a diagram of a trust aware network visualization system; and

FIG. 13 illustrates a diagram of an embodiment computing platform.

Corresponding numerals and symbols in the different figures generally refer to corresponding parts unless otherwise indicated. The figures are drawn to clearly illustrate the relevant aspects of the embodiments and are not necessarily drawn to scale.

### SUMMARY OF THE INVENTION

Technical advantages are generally achieved, by embodiments of this disclosure which describe methods for generating and using trust blueprints in security architectures.

In accordance with an embodiment, a method for gauging trust between devices is provided. In this example, the method comprises gathering a reputation-based attribute corresponding to a trustee device that is attempting to access or provide a service in a network. The first reputation-based attribute indicates a level of trust between a network device and the trustee device. The method further includes calculating a trust level between the truster device and the trustee device in accordance with at least the reputation-based attribute, and authorizing the trustee device to access or provide the service in the network when the trust level between the truster device and the trustee device exceeds a threshold. An apparatus for performing this method is also provided.

In accordance with another embodiment, a method for distributing trust information is provided. In this example, the method includes establishing a level of trust between a network device and a trustee device at the beginning of a period, and providing a reputation-based attribute to a truster device. The reputation-based attribute indicates the level of trust between the first network device and the trustee device. The method further includes updating the level of trust between the network device and the trustee device during a subsequent period, and providing an updated reputation-based attribute to the same truster device or a different truster device during the subsequent period. The updated reputation-based attribute indicates the updated level of trust between the network device and the trustee device. An apparatus for performing this method is also provided.

### DETAILED DESCRIPTION OF ILLUSTRATIVE EMBODIMENTS

The making and using of embodiments of this disclosure are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Aspects of this disclosure provide trust management schemes that allow a truster device to gauge the trust-worthiness of a trustee device based on the trustee device's reputation amongst other network devices, e.g., peers, trust brokers, etc. For example, a truster device may gather reputation-based attributes from other network devices that indicate a level of trust between those network devices and a trustee device. The truster device may then use those reputation-based attributes to determine a trust level between the truster device and the trustee device without relying on a dedicated authenticator, e.g., a AAA server, etc. The truster device may permit the trustee device to access (or provide) a service when the determined trust level exceeds a trust threshold associated with that service. A trust threshold for a service may depend on the service type, as well as the context in which the service is being accessed/provided. Reputation-based attributes may be exchanged between peers of a federated trust domain, as well as between brokers in different federated trust domains. Embodiment trust management schemes disclosed herein may provide a blueprint for enabling interested parties to determine the trustworthiness of disparate and heterogeneous computing entities, which include, inter alia, people, organizations, devices, and services. Aspects of this disclosure also enumerate various utilization scenarios that articulate how trust management frameworks may address current and future computing environments needs. These and other aspects are discussed in greater detail below.

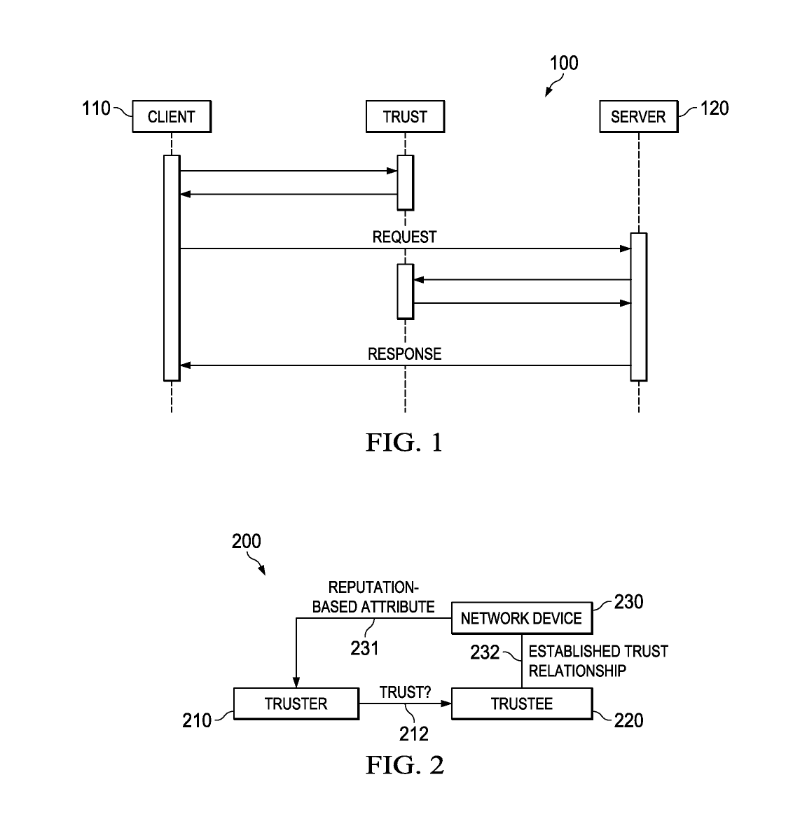

FIG. 1 illustrates a diagram of a system for establishing dynamic trust between a client 110 and a server 120. Trust is a property that leverages dynamic verification and updates for such trust relationships, taking contexts, and entity specific (e.g., personal) policies into account. Entities are the objects between which trust is established and maintained. An entity may be defined as any person, place, or thing with a distinct and independent existence that is capable of trusting and/or being trusted. Each entity may be uniquely identified. One possible identification mechanism may be the Extensible Resource Identifier defined by the OASIS XRI Technical Committee. Entities can have a duality as trusters and/or trustees. A truster positions the entity as the one that is trusting another entity (i.e., a trustee). A trustee positions the entity as the one that is being trusted by a truster. Trusters may have a belief policy and one or more contexts

Aspects of this disclosure allow truster devices to make trust determinations based on a trustee's reputation for trust-worthiness. FIG. 2 illustrates a diagram of a network 200 comprising a truster device 210, a trustee device 220, and a network device 230. In this example, the network device 230 has an established trust relationship 232 with the trustee device 220, and the truster device 210 is determining whether or not to establish a trust relationship 212 with the trustee device 220. When gauging whether or not to trust the trustee device 220, the truster device 210 may gather a reputation-based attribute 231 from the network device 230 that indicates a parameter (e.g., trust level) associated with the established trust relationship 232. The network device 230 is a device (peer node, trust broker, etc.) that is not authorized to provide federated authentication/authorization in a trust domain of the truster device 210. Stated differently, the network device 230 does not have trustee responsibilities in the trust domain of the truster device 210, and therefore cannot unilaterally establish the trust relationship 212. Instead, the network device 230 may notify the truster device 210 of a trust reputation of the trustee device 220 so that the truster device 210 may determine a trust level between the truster device 210 and the trustee device 220.

The truster device 210 may consider other factors in addition to the reputation-based attribute when determining the trust level between the truster device 210 and the trustee device 220. For example, the truster device 210 may consider evidenced-based attributes provided by the trustee device 220, or by some other device, indicating a performance capability of the trustee device 220, e.g., a level of securitization provided by the trustee 220. The performance capability may include a level of service reliability, a level of securitization (e.g., encryption capability, etc.), a quality of service, or any other performance related criteria associated with the trustee's 220 ability to provide the service. The truster device 210 may also consider a credibility of the network device 230.

The truster device 210 may decide to trust the trustee device 220 when the calculated trust level exceeds a threshold. The threshold may be dependent on the type of service being accessed or provided by the trustee device 220. For example, some or service types may require a higher trust level than other service types. The threshold may also depend on the context in which a service is being provided or accessed. For example, a resource/service being accessed for banking may require a higher level of trust than that same resource/service being accessed for gaming.

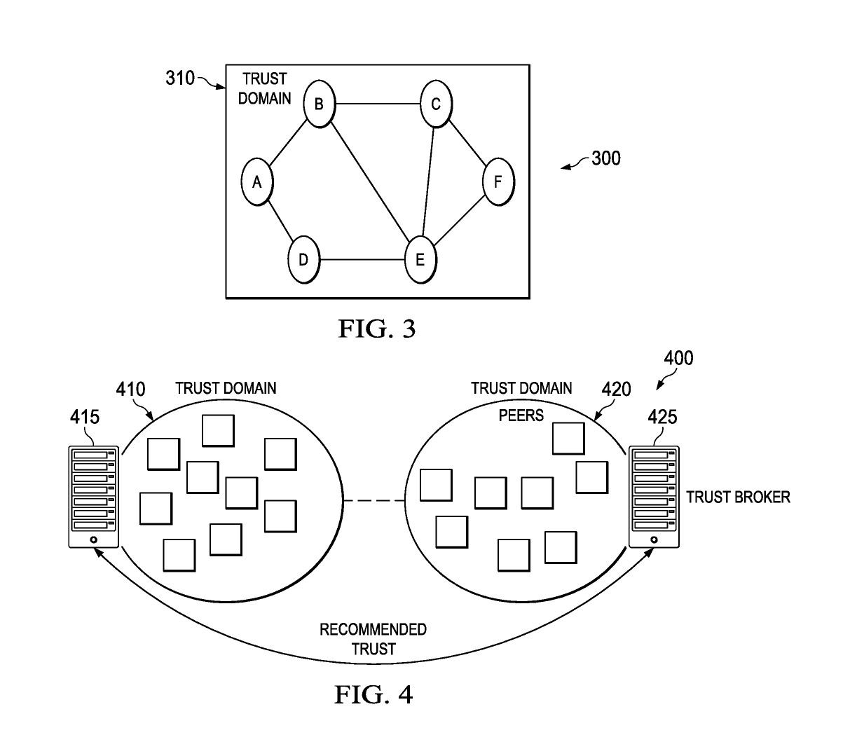

Reputation-based attributes may be exchanged in a variety of different ways. For example, reputation-based attributes can be exchanged by peers in a federated trust domain. FIG. 3 illustrates an embodiment network architecture 300 adapted to establish trust relationships by exchanging reputation-based attributes between peer nodes (e.g., A, B, . . . F) of a federated trust domain 310. Each peer node may maintain a local trust table to store trust information of other peer nodes in the federated trust domain 310. Trust information may also be generated when a peer node interacts with an outside entity. The trust information can then be distributed (e.g., periodically, on-request, etc.) to other peer nodes, and used by those peer nodes to gauge a trust level between those peer nodes and the outside entity.

Reputation-based attributes can also be exchanged between different federated trust domains. FIG. 4 illustrates an embodiment network architecture 400 adapted to establish trust relationships by exchanging reputation-based attributes between different federated trust domains 410, 420. In some embodiments, trust brokers 415, 425 will facilitate reputation-based attribute exchanges between the trust domains 410, 420. In other embodiments, reputation-based attributes will be exchanged directly between individual nodes in different trust domains. In a centralized broker-based trust aggregation topology, the trust landscape may be divided into trust domains. Trust agents/entities may inherit the trust properties of the domain they are associated with. This increases the scalability of the overall approach. Trust entities may rely on the trust broker to manage trust. As Domain trust agents, trust brokers store other domains' trust information for inter-domain cooperation. Essentially, the trust information stored reflects trust value for a particular resource type (compute, storage etc.) for each domain. Trust Brokers also recommend other domains trust levels for the first time inter-domain interaction. A decentralized distributed hash table (DHT) based 3rd Party Trust Management may be used for efficiently managing various trust domains. Individual Entities themselves do not need to take any responsibilities for managing the trust model. Instead the responsibility is delegated to the 3rd party trust broker node. However, this approach may have various disadvantages, such as performance bottlenecks, single point of failure, etc.

On one hand, authentication is the process through which an entity (e.g., a person, device or service) provides sufficient credentials such as passwords, tokens, public key certificates (using PKI) or secret keys to satisfy access requirements of a resource. The credentials may be established based on a pre-existing membership of that entity. Authentication is essentially a process of ensuring “irrefutable knowledge” of the trustee (entity), thereby allowing users, computers, and/or devices to know with whom they are communicating with.

On the other hand, Authorization is the process used to determine what services or resources an irrefutably known authenticated user, computer or a device, can access. Authorization is a process for protecting resources and information while allowing seamless access for legitimate use of those resources. It allows security administrators to enact authorization entitlement policies in an easy to maintain and simple to monitor fashion.

Historically, authentication services have been useful in identifying a person attempting to gain access (e.g., to log on) to a system/network. More recently, authentication needs have evolved to go beyond the scope of traditional log on procedures. For example, modern authentication schemes include public key infrastructure (PKI) based “Digital Signature” techniques. Cryptographic algorithms based digital signatures, as the name implies, mark an electronic document (digital certificate) to signify its association with an entity. A trusted third party that certifies the digital signature issues the digital certificate.

Irrespective of the authentication mechanism used, a successful authentication process assigns a static/fixed role to the requesting entity (e.g., the trustee). In turn, authorization processes determine access privileges based on the fixed role assignment. It is important to note that access control to resources is not assigned directly to the “requester” entities but to abstractions known as “roles”. As “entities” are assigned to different roles they indirectly receive the relevant access control privileges.

Distributed computing and cloud models are moving towards a federated inter-cloud model along with the near ubiquity and pervasiveness of smart devices and sensors included in the Internet of Things. This migration poses difficult challenges for classic authentication and authorization methods. With the humanization of Internet technologies whereby smart devices are increasingly taking on more intelligent and autonomous roles for their owners, it is equally important for services to obtain real-time and context-specific information about trustworthiness of its users.

Effective provisioning and delivery of application services in an efficient and highly secured manner are the key challenges faced going forward. It has become increasingly important to be able to generate dynamic, granular security policies for federated ubiquitous systems. Current security techniques that are widely being employed include sand-boxing, PKI based cryptography, and other access control and authentication mechanisms. These mechanisms, however, are very static, inflexible and not granular enough in order to make efficient and informed decisions for the future computing environment.

More specifically, explicit trust is not addressed by the contemporary fabric of the Internet. Instead, contemporary rudimentary trust mechanisms apply to individuals, and are not included as an integral part of the fabric of the Internet and the Web itself. Current conventional trust mechanisms are inadequate at addressing granular level and real-time, contextual trust issues in the highly decentralized open environments. Trust needs to be established from the viewpoint of both parties, including both service requesters and service providers. Service requester's trust with respect to the service provider may be different from service provider's trust with respect to the requester. From the service requester's perspective, trust towards the service provider signifies correct and faithful allocation of resources as part of the efficient execution environment with respect to established trust and other security policies. From the service provider's perspective, trust towards service requester will generate a legitimate request consisting of virus free code and will not produce malicious results and does not temper other results/information/code present at service provider's end.

Aspects of this disclosure provide detail blueprints of a trust management system, and describe how components of this system interact with one another. Aspects of this disclosure provide various trust management schemes and blueprints for enabling a framework so that interested parties can determine the trustworthiness of disparate and heterogeneous computing entities. Aspects of this disclosure also enumerate various utilization scenarios that articulate how trust management frameworks can be highly invaluable for addressing current and future computing environment needs.

Aspects of this disclosure describe various components of trust management systems in detail. Aspects of this disclosure provide a general foundation for building various constituents of the trust system. Aspects of this disclosure demonstrate trust management system's paradigm shift in comparison to the typical role-based access control computer security model.

In future networks, the identity of some entities may not be known in advance. In such an environment, traditional fixed “role” assignment becomes non-viable. Although PKI based credential mechanisms implement a notion of trust, this trust is static and binary in nature. Access privileges are allowed or credentials are rejected and the “trustee” entity does not get the access rights. In such a highly de-centralized environment, role assignment needs to enable dynamic trust values to be allocated to trusted entities. Trust based authorization mechanisms, in turn, may be able to leverage dynamic trust value assignments in a manner that allows for access control decisions to be made in a dynamic manner.

Trust reflects the expectation one actor has about another's future behavior to perform expected activities dependably, securely, and reliably based on experience collected from previous interactions and relevant external sources. Trust can be is based on a paradigm shift assumption that formalizes trust so that trust considerations may be added to how future services and computer systems communicate amongst each other.

Embodiment trust models allow trusting entities (referred to as trusters) to determine permissions based on a principle's set of attributes instead of a principle's identity. Trust attributes may include evidence-based attributes as well as reputation-based attributes. Reputation-based attributes may occur when entities endow other unknown entities in order to gain access to services or resources in a highly federated distributed environment.

Aspects of this disclosure provide various trust properties. In some embodiments, trust is not a transitive property. For example, if a first entity trusts Alice, and Alice trusts John, it does not necessarily follow that the first entity trusts John. Essentially, trust relationship between two entities is a vector that consists of trust value in conjunction with direction. Trust can be Contextual in that a truster may have different and independent sets of trust relationships for different roles and/or configurations. For example, an entity can be a tourist, a hobbyist, an employee, a father, a husband, a consultant, a teacher or a volunteer, to name a few. A mobile device may be used in a security zone with restrictions or in a public place playing games. Trust relationships vary depending on such situations that arise from these contexts. Trust can be Granular in that an assessment of many trust-related scores taken from the evidences provided to score the evidence, not just one cumulative and global score value. Trust assessments can be Belief-based in that different trusters may have different beliefs of trust. Some trust until trust is broken, while others distrust until trust is earned. Trust assessments can be Situational in that the applicable context may depend on the situation. Trust assessments can be Intent-driven in that while a situation defines the context, intent defines the trust scoring. Trust assessments can be Continuously Reevaluated based on changing situations, contexts, and/or evidence. Trust scores may change based on continuous assessment of the trustee's relationships, thereby providing dynamic trust establishment. A trust-based paradigm shift takes the blind trust method and introduces a trust query allowing both the client and the server to proceed based on their latest and up-to-date understanding of the trust relationship between the two entities.

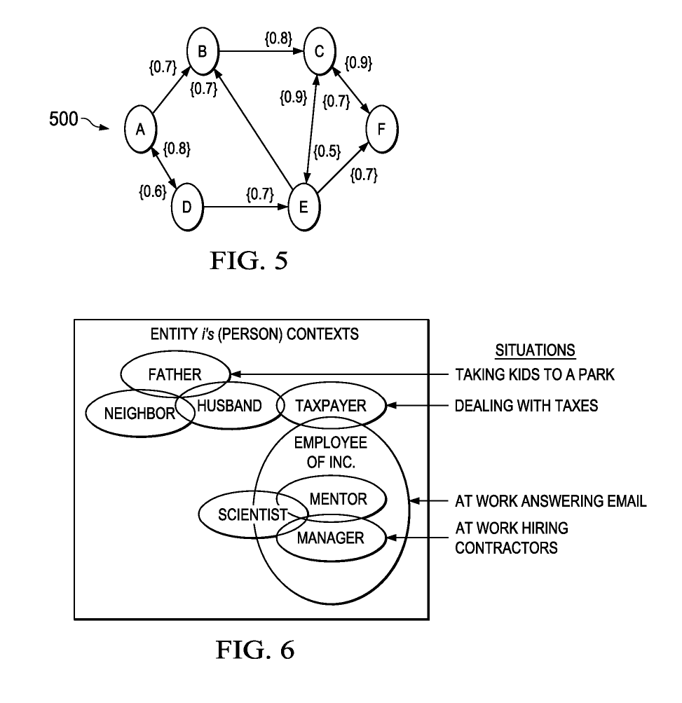

Notably, peer nodes may store trust information for a subset of the peer nodes within a given federated network domain. FIG. 5 illustrates a point-to-point (P2P) Trust Management topology 500 in which each peer node stores trust information of one or more of their immediate neighboring peer nodes. A trust Vector Aggregation Algorithm can infer indirect trust among peers. Each member entity itself may cooperate and share responsibilities to manage the local level trust index. Trust value for all nodes may be determined algorithmically. In such a decentralized environment, finding “Most Trustable Path” so that the trust path yields the highest trust value from thousands or millions of peers may be a computationally expensive task. Also, trust propagation to each peer in a vast network of peers may consume bandwidth and/or result in network update latency. These issues can be addressed/mitigated by P2P topology design. The P2P Trust Management topology 500 may include identity providers (IdPs) and/or service providers (SPs). The arrows demonstrate the trust relationship, and the numbers in the brackets indicate a level of trust associated with that relationship or a credibility relationship.

Aspects of this disclosure provide trust based authorization in open and highly decentralized environments. Trust based authorization mechanisms leverage the dynamic trust value assigned to the “trustee” entity and makes the access control decisions in a highly dynamic manner. The truster decides permissions based on principle's set of attributes instead of principle's identities. Trust attributes may include evidence-based as well as reputation-based attributes as covered in the previous section.

In very simplistic terms, “Trust based Authorization” process is a mathematical equation. On one side of the equation is the Security Demand (SD) of an entity. On another side of the equation is the Trust Value (TV) that reveals of another entity. These two must satisfy a security assurance condition so that “TV”>=“SD”. Trust relationship between two entities may be represented by a vector, and may be related to a particular context. The trust vector is a vector of trust value and trust direction, where trust value is defined as a real number in the range [0 . . . 1] and direction is defined as a directed edge in the trust graph. The edge in a graph represents the rating for a combination of all direct transactions between two peers. Trust value itself comprises of three key components—Evidence, Direct Experience, & Recommendations from others. In simple terms, trust relationship between entity A and B can be described as follows: TV(A→B)=[_{A}E_{B}^{c},_{A}D_{B}^{c},_{O}R_{B}^{c}], where _{A}E_{B}^{c} represents the level of evidence demonstrated by entity B to entity A under context c. _{A}D_{B}^{c} represents the magnitude of direct experience of entity A in relation to entity B under context c. _{O}R_{B}^{c} represents the cumulative effect of all recommendations from all other entities for entity B under context c. Each of these three components is expressed in terms of a numeric value in the range [0 . . . 1].

Trusters may ascertain trust relationships based on different contexts and situations. Truster contexts are a way to partition an entities singular notion of trust into different sets of related trust domains. Trust context may be established prior to trust assessment. Specific contexts can be selected based on specific situations that are present at the time of trust determination. FIG. 6 illustrates a diagram of trust contexts can apply to various situations. As shown, a truster evaluates trust or risk assessments based on both contexts and situations.

Trusters may also perform trust assessments on belief policies and intent. Trusting entities may form their own believe policies, which may be applied during trust assessment. A Belief Policy may determine how trust values are interpreted to derive a Boolean trust value for a specific scenario. A final trust score of 0.8 may signal one to trust but another not to. Belief Policies maintain trust value thresholds, and allow the entity to change its belief over time as trust is gained or reduced. Additionally, the intent of a potential trustee and/or situation may be taken into account. For example, a manager talking to a non-employee in a conference room with a human resources representative present may identify the context as that of an interview. But the interviewers (truster) intent may affect the trust determination of the interviewee (trustee). If the interviewer's intent is to hire a friend, then risk acceptance may be increased due to the trustee having a higher level of trust. If the interviewer's intent is to hire a replacement, their trust may be lower. Thus intent is an adjustment to one's belief policy is important in allowing for more accurate trust assessment of a given context identified by a specific situation.

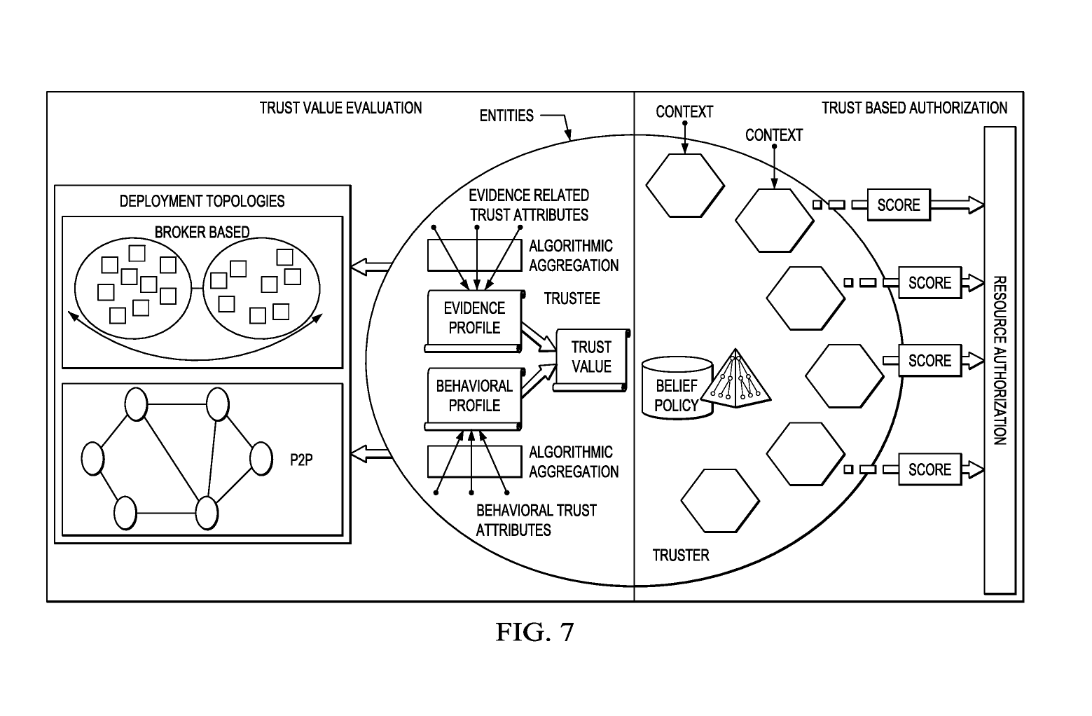

FIG. 7 illustrates an embodiment trust management system. In some embodiments, trusters may perform Trust Value Evaluations when making trust assessments. In a highly de-centralized environment, the contemporary static role assignment mechanism needs to be evolved in such a manner that it enables a dynamic trust value assignment to a “trustee” entity. Trust based authorization mechanism, in turn, leverages the dynamic trust value assigned to the “trustee” entity and makes the access control decisions accordingly in a highly dynamic manner.

“Trust Value Evaluation” processes may include collecting relevant information, which may be used to establish trust relationships, dynamically monitor trust relationships, and/or adjust existing trust relationships. This process assigns a single-valued scalar numeric value in the range [0 . . . 1]. Lower trust value signifies lack of trust, while higher value denotes more trustworthiness of an entity. A trust value of 0 represents the condition with the highest risk for an entity and 1 representing the condition that is totally risk-free or fully trusted.

Trust can be related to a particular context. An entity A needs not trust another entity B completely. Entity A may calculate the trust associated with entity B in some context pertinent to a situation. The specific context may depend on the nature of application. Trust can be evaluated under a single context, or under multiple contexts.

In an embodiment, trust values can be determined using an evidence-based model, a reputation-based model, or combinations thereof. In evidence-based models, a trust value is assigned to an entity based on some evidence (e.g., self-defense evidence, etc.) explicitly or implicitly manifested by the entity. In reputation-based models, direct experience coupled with indirect recommendations may be used to establish the trust value of an entity.

Using one or both of these models, trust rating values may be obtained by applying different mathematical functions/algorithms to relevant trust attributes of the entity seeking trust. Both evidence-based and reputation-based attributes may be assigned respective weights as part of the trust calculation algorithm.

Aspects of this disclosure provide evidence-based trust models. In evidence-based models, trust is considered as a set of relationships established with the support of evidence. Evidence can be anything a policy uses to establish a trust relationship, such as attendance list, annual report, or access history. For example, in case of a web service resource, the intrinsic trust value calculation algorithm may factor in web service attributes such as dependability characteristics (e.g., Accessibility, Availability, Accuracy, Reliability, Capacity, Flexibility etc.) self-defense characteristics (e.g., Authentication, Authorization, Non-repudiation, encryption, privacy, Anti-Virus Capabilities, Firewall Capabilities, Intrusion Detection Capabilities etc.), performance characteristics (e.g., latency, throughput, etc.), and others.

Aspects of this disclosure provide reputation-based trust models. In a reputation-based model, trust may be modeled based on human society, where human beings get to know each other via direct interaction and through a grapevine of relationships. In a large distributed system, every entity can't obtain first-hand information about all other entities. As an option, entities can rely on second-hand information or recommendations. Reputation is defined as perception that an entity creates through past actions about other entity's intentions and track record. The reputation assessment of an evaluated entity by an evaluator entity involves collecting information such as direct trust and recommender trust. Direct trust may be based on the evaluator's own interaction experiences with the evaluated entity, as may be available when the evaluator entity has first-hand experience of interacting with evaluated entity in the past. Recommender trust may be based on peer recommendations from other entities who have interacted with the evaluated entity before. Attributes such as prior success rate, turnaround time, cumulative site utilization, and others may be examples of reputation trust. Time is a dimension for reputation, as reputation may build with time. In some instances, reputation enhances or decays as the time goes along.

Aspects of this disclosure provide a recommendation protocol. For example, entity A needs a service from entity D. A knows nothing about the quality of D's service, so A asks B for a recommendation with respect to the service category, assuming that A trusts B's recommendation within this category. When B receives this request and finds that it doesn't know D either, B forwards A's request to C, which has D's trustworthiness information within the service category. C sends a reply to A with D's trust value. The path (A)X(B)X(C)X(D) is the recommendation path. When multiple recommendation paths exist between the requester and the target, the target's eventual trust value may be the average of the values calculated from different paths.

Time may be a dimension for reputation. As any relationship, trust may decay with time. For example, if an entity has not interacted with another entity for some time, then the trust value between these two entities is likely to be weaker. To account for the time dimension, a time decay factor can be included as part of the trust calculation algorithm.

Aspects of this disclosure provide Trust Normalization Policy & Unit of Measure (UOM) Standardization. Trust attributes (“Evidence-based” as well as “Reputation-based” attributes) may be assigned respective weights as part of the trust calculation algorithm. Trust normalization policy may enable entities to deterministically assign weights and attributes during trust value calculation. During evaluation of a trust value, a truster may assign different weights to the different factors that influence trust. The weights will depend on the trust evaluation policy of the truster. So if two different trusters assign two different sets of weights, then the resulting trust value will be different. The trust normalization policy addresses this particular issue. The trust normalization policy to go along with the “Evidence-based” model and “Reputation-based” model forms the complete truster's trust evaluation policy.

Aspects of this disclosure provide embodiment trust management topologies, including centralized broker-based trust aggregation topology as well as network based peer-to-peer decentralized topology. Whether a trust topology is centralized or decentralized determines the feasibility and complexity of a trust value evaluation mechanism. In a centralized system, a central node may take many or all of the responsibilities of managing reputations for all the members. In a decentralized system, e.g., a peer-to-peer system, the members in the system may cooperate and share the responsibilities of managing reputation.

Generally speaking, mechanisms for managing reputation in centralized systems may be less complex and easier to implement than mechanisms for managing reputation in decentralized systems. However, mechanisms for managing reputation in centralized systems may utilize powerful and reliable centralized servers and a lot of bandwidth for computing, data storage, and communication.

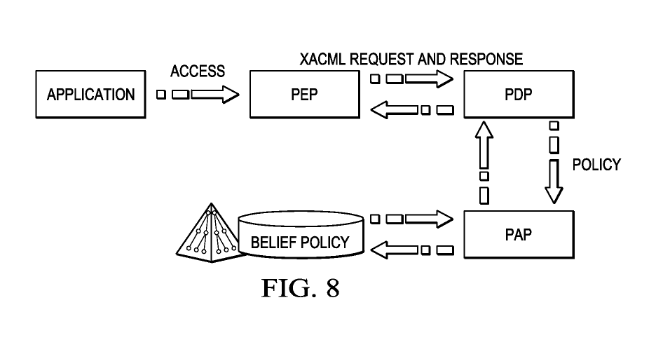

FIG. 8 illustrates an extensible access control markup language (XACML) compliant policy management system. This system may be implemented in conjunction with embodiment trust based authorization schemes. XACML provides a standardized language and method of access control and policy enforcement, and is an XML-based language for access control that has been standardized in OASIS. XACML describes both an access control policy language and a request/response language. The policy language is used to express access control policies (who can do what when). The request/response language expresses queries about whether a particular access should be allowed (requests) and describes answers to those queries (responses).

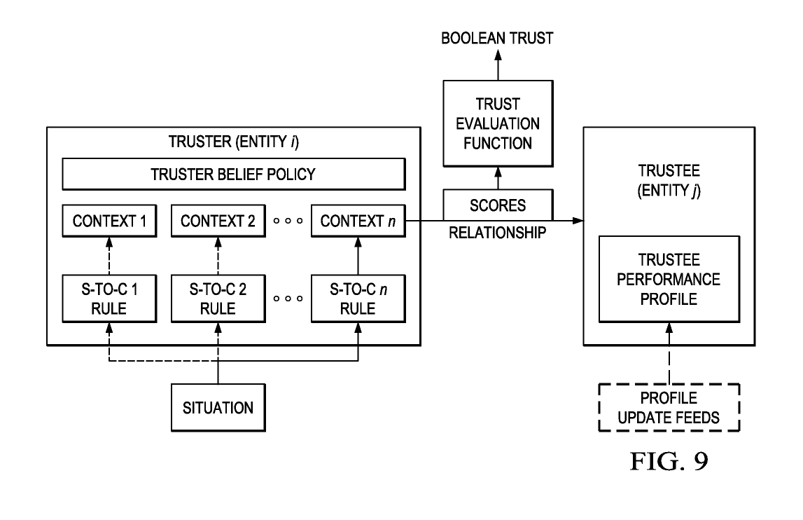

In a typical XACML usage scenario, a subject (e.g. human user, device) wants to take some action on a particular resource. The subject submits its query to the entity protecting the resource. This entity is called a Policy Enforcement Point (PEP). The PEP forms a request (using the XACML request language) based on the attributes of the subject (trust value in our case), action, resource, and other relevant information. The PEP then sends this request to a Policy Decision Point (PDP), which examines the request, retrieves policies (written in the XACML policy language) that are applicable to this request, and determines whether access should be granted according to the XACML rules for evaluating policies. That answer (expressed in the XACML response language) is returned to the PEP, which can then allow or deny access to the requester. Policy Administration Point (PAP) is used to get to the policies; the PDP uses the PAP where policies are authored and stored in an appropriate repository. FIG. 9 illustrates a trust based assignment process.

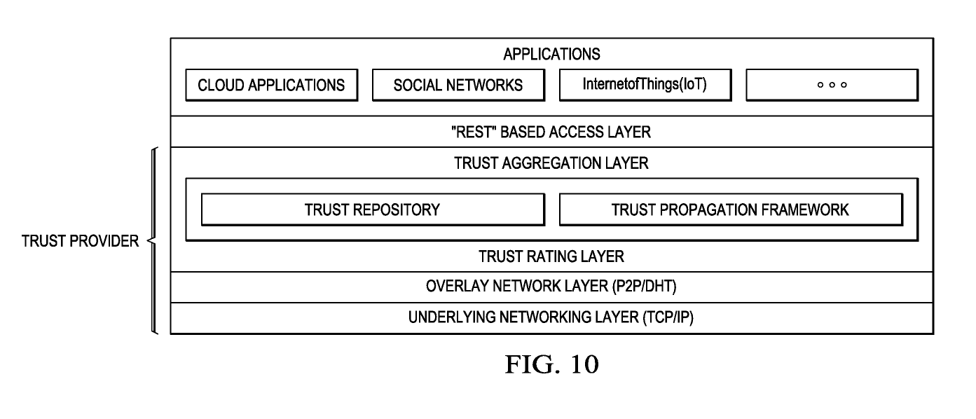

FIG. 10 illustrates a trust management conceptual layered architecture comprising a trust rating layer, a trust aggregation layer, and a trust access layer. The trust aggregation layer is responsible for aggregation of distributed trust scores in a peer-to-peer environment. It is based on mathematical algorithm for fast and lightweight trust score aggregation. The trust access layer provides entities to extract trust information from the trust model. This RESTful API specification is for the REST interface of the Trust System. The API set includes mechanisms related to entities (e.g., create, list, find, entity details, modify, delete, etc.), entity context (e.g., create, list, find, entity details, modify, delete, etc.), entity belief policy (e.g., get, modify, etc.), entity relationship (e.g., create, find, list, get, modify, etc.), trust determination, and others.

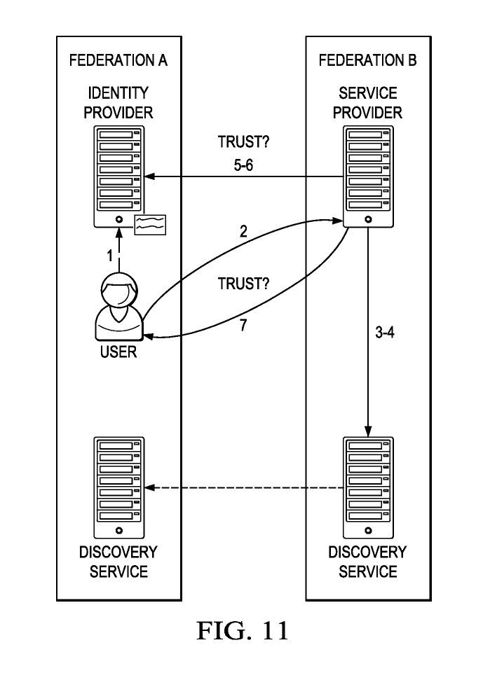

Aspects of this disclosure provide trust management use cases, which articulate how embodiment trust management frameworks are useful for addressing current/future computing environment needs. Federated Identity Management is one trust management use case that would benefit from embodiment trust management frameworks provided by this disclosure. FIG. 11 illustrates a trust aware federated identity management network. Traditional approaches to identity federation are based on static relationships. In a static federation, relationships among identity providers (IdPs) and Service providers (SPs) are manually pre-configured in their metadata repository.

As shown, the user may register with an IdP of federation A (step 1), and begin browsing a server in federation B (step 2). The server in federation B may detect that the IdP of federation A is associated with the user using a discovery service (step 3), and retrieve trust information for the IdP in federation A (step 4) to determine that the IdP in federation A can be trusted (steps 5). Next, the server in federation B may confirm with the IdP in federation A that the user can be trusted (step 6), and authorize the user to access the requested service (step 7). The server in federation B may not know the IdP in federation A before the user requests the service, and may discover the IdP in federation A dynamically (e.g., on the fly).

The question of whether an entity can trust another depends on if they can find each other in the pre-wired metadata repository, thus this question cannot be answered in a dynamic manner due to the static nature of the meta data. Current, “Federated Identity Management” solutions lead to problems with scalability and deployment in real-time dynamic environment such as mobile networks and “Internet of Things” in general. Firstly, every new relationship between any two entities must be added manually as such a static federation cannot be quickly and easily expanded to accommodate hundreds, thousands or even millions of IdPs and SPs nodes. In essence, a static “Identity Federation” cannot be deployed in a real-time environment like a mobile network or in “IoT” environment where devices may potentially access each other across federation boundaries and at any time.

The proposed “Trust Model” enables a dynamic federation environment, in which the IdPs and SPs will be regarded as peers of a trusted network that evolves over time. A trust relationship between two entities is regarded as a network connection. In such a dynamic federation, an SP does not need to know an IdP beforehand. A trust relationship will be created on demand and the trust value, namely how much an IdP can be trusted will be determined on the fly.

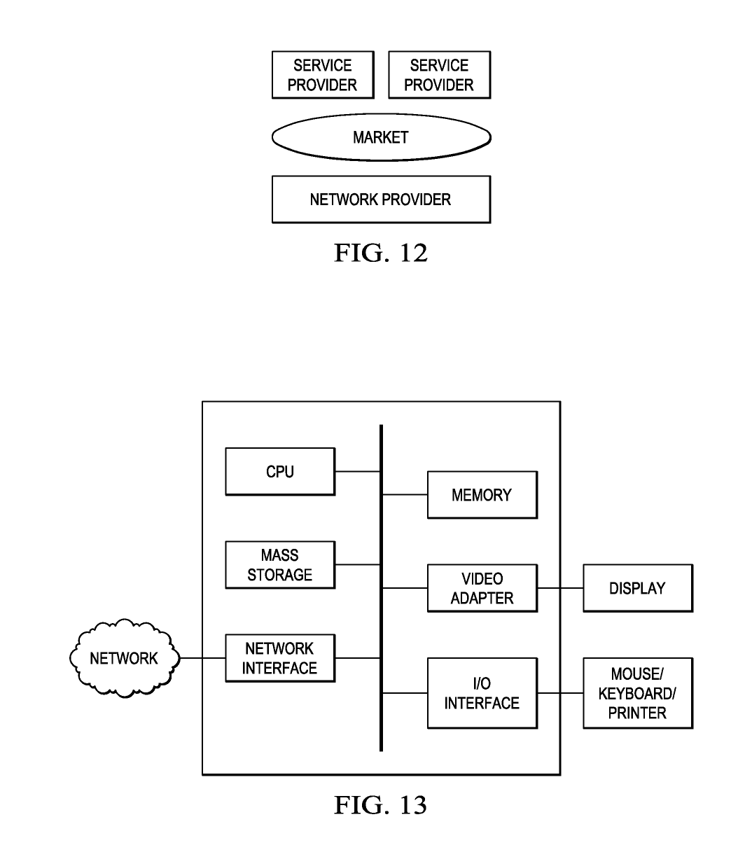

Trust aware network virtualization is another embodiment trust management frameworks. FIG. 12 illustrates a trust aware network visualization system. In this example, the service provider may be able to trust than an underlying infrastructure provider will fulfill its part of a service level agreement by providing a stipulated quality of service (QoS). The may reduce the risk undertaken by the parties, and allow them to leverage underutilized resources. It may also allow for quick service deployment, and allow networks to adapt to unexpected changes in network conditions, e.g., increase/decrease in traffic, etc.

Most network traffic does not flow in steady and easily predictable streams, but in short bursts, separated by longer periods of inactivity. This pattern makes it difficult to predict peak loads. “Bandwidth on Demand” is useful for applications, such as backups, files transfers, synchronization of data bases, and videoconferencing, and allows the user to pay for only the amount of bandwidth used. It is a technique that allows the user to add additional bandwidth as the application requires it.

Traditionally in a network virtualization environment, trust if addressed, is generally addressed from the security and privacy point of view only. Authentication, authorization, access control, ensuring integrity of information and protecting the source of information are used to provide a secure virtual network. However, there are other trust related aspects that need to be taken into consideration. For example, entities should be able to trust that an underlying infrastructure provider will fulfill its part of the SLA by providing the agreed Quality of Service (QoS). A SP assesses the quality of service of an infrastructure network provider involved in a virtual network in terms of availability of resources, reliability, confidentiality and integrity, and adaptability to network conditions. The feedbacks sent by different service providers are gathered and stored. A Trust Management Service is used to keep track of trust data of infrastructure providers. In mapping a virtual network, the SP will take into consideration the reputation of the infrastructure providers.

Mapping a virtual network request requires the selection of specific nodes and links according to the requirement of a service provider in terms of resources (e.g., location and CPU of the nodes, and the bandwidth of the links) and cost. If service providers consider only the cost, the infrastructure providers may be tempted to reduce the price by minimizing the quality of the physical underlying network. To make the right decisions, trust information of the infrastructure providers is incorporated into account while performing a VN (Virtual Network) mapping. Avoiding un-trusted physical network providers, where failure of nodes and links could easily happen, will improve the service provided to the users. Service providers may reward reputable infrastructure providers by higher priority/probability of involvement in future VN mapping requests.

Aspects of this disclosure provide a Trust Model for Device Mobility. Enterprise customers/providers may need a mechanism for trust-based mobile device control management for various reasons. One reason is that mobile devices set up for only one security domain with static access policy limit usability and increases costs. Another reason is that enterprise networks are adopting hybrid public/private cloud services. Another reason is that enterprise security needs must balance personal privacy needs and usability. Another reason is that enterprises may want to accept the coexistence of personal and corporate apps and data. Another reason is that enterprises can adopt dynamic and real-time control policies based on managing risk with Granular Trust Attributes (e.g., defined for users, devices, apps, etc.), where trust is learned and continually verified and adjusted, and where trust (and policies) are mutual and bi-directional.

FIG. 13 is a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

The following references are related to subject matter of the present application. Each of these references is incorporated herein by reference in its entirety:
Bernstein, D., Ludvigson, E., Sankar, K., Diamond, S., and Morrow, M., Blueprint for the Intercloud—Protocols and Formats for Cloud Computing Interoperability. In Proceedings of ICIW '09, the Fourth International Conference on Internet and Web Applications and Services, pp. 328-336 (2009).
Buyya, R., Pandey, S., and Vecchiola, C.: Cloudbus toolkit for market-oriented cloud computing. In Proceedings of 1^{st} International Conference on Cloud Computing (CloudCom) (2009).
Bernstein, D, Vij, D., Intercloud Exchanges and Roots Topology and Trust Blueprint, In Proceedings of the IEEE 2011 International Conference on Internet Computing, Las Vegas, USA (2011).
E. F., Churchill, On Trust Your Socks to Find Each Other, Yahoo Interactions, March 2009.
K. Thompson, Reflections on Trusting Trust, Communications of the ACM, August 1984.
L. J. Hoffman, K. Lawson-Jenkins and J. Blum, Trust Beyond Security: An Expanded Trust Model, Communications of the ACM, July 2006.
M. C. Huebscher and J. A McCann, A Learning Model for Trustworthiness of Context-awareness Services, Proceedings of the 3^{rd} Int'l Conf. on Pervasive Computing and Communications Workshops, 2005.
OASIS Extensible Resource Identifier (XRI) TC, http://www.oasis-open.org/committees/tc_home.php?wg_abbrev=xri
J. Goldbeck and J. Hendler, Inferring Reputation on the Semantic Web, ACM WWW 2004, May 2004.
F. G. Marmol and G. M. Perez, Security threats scenarios in trust and reputation models for distributed systems, Elsevier, Computers & Security 28, 2009.
S. Ramchurn, C. Siena, L. Godo, and N. Jennings. Devising a trust model for multiagent interactions using confidence and reputation. International Journal of Applied Artificial Intelligence, 18(9-10):91-204,2005.
J. Goldbeck, Semantic Web Interaction through Trust Network Recommender Systems.
K-J. Lin, H. Lu, T. Yu and C. Tai, Reputation and Trust Management Broker Framework for Web Applications.
R. Zhou and K. Hwang, Trust Overlay Networks for Global Reputation Aggregation in P2P Grid Computing, IEEE IPDPS, 2006.
T. Repantis and V. Kalogeraki, Decentralized Trust Management for Ad-Hoc Peer-to-Peer Networks, ACM MPAC, 2006.
S. Ayyasamy and S. N. Sivanandam, Trust Based Content Distribution for Peer-to-Peer Overlay Network, IJNSA 2010.
G. H. Nguyen, P. Chatalic, and M. C. Rousset, A Probabilistic Trust Model for Semantic Peer to Peer Systems, DAMAP '08, March 2008.
OASIS xEtensible Access Control Markup Language (XACML) TC, http://www.oasis-open.org/committees/tc_home.php?wg_abbrev=xacml

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for gauging trust between devices, the method comprising:
gathering, by a truster device, a first reputation-based attribute corresponding to a trustee device attempting to access or provide at least a first service in a network, wherein the first reputation-based attribute indicates a level of trust between a first network device and the trustee device;
calculating a trust level between the truster device and the trustee device in accordance with at least the first reputation-based attribute; and
authorizing the trustee device to access or provide the first service in the network when the trust level between the truster device and the trustee device exceeds a first threshold.

2. The method of claim 1, wherein the first network device is not authorized to provide federated authentication or authorization in a trust domain of the truster device.

3. The method of claim 1, further comprising:
authorizing the trustee device to access or provide a second service in the network when the trust level between the truster device and the trustee device exceeds a second threshold, the second threshold being different than the first threshold.

4. The method of claim 3, wherein the second service comprises a different type of service than the first service.

5. The method of claim 3, wherein the second service and the first service comprises the same type of service under a different context.

6. The method of claim 1, calculating the trust level between the truster device and the trustee device in accordance with at least the first reputation-based attribute comprises:
identifying a direct reputation-based attribute corresponding to a previous interaction between the truster device and the trustee device, the direct reputation-based attribute indicating a previous level of trust between the truster device and the trustee device, wherein the first reputation-based attribute comprises an indirect reputation-based attribute; and
calculating the trust level between the truster device and the trustee device in accordance with both the direct reputation-based attribute and the indirect reputation based attribute.

7. The method of claim 1, wherein the truster device and the first network device are peers in a federated network domain.

8. The method of claim 7, wherein the truster device gathers the first reputation-based attribute directly from the first network device.

9. The method of claim 8, further comprising:
gathering, by the truster device, a second reputation-based attribute corresponding to the trustee device directly from a second network device in the federated network domain, wherein the second reputation-based attribute indicates a level of trust between the second network device and the trustee device, and
wherein calculating the trust level between the truster device and the trustee device comprises calculating the trust level between the truster device and the trustee device in accordance with both the first reputation-based attribute and the second reputation-based attribute.

10. The method of claim 9, wherein calculating the trust level in accordance with both the first reputation-based attribute and the second reputation-based attribute comprises:
adjusting the level of trust indicated by the first reputation-based attribute in accordance with a credibility level of the first network device, thereby obtaining a first weighted trust component;
adjusting the level of trust indicated by the second reputation-based attribute in accordance with a credibility level of the second network device, thereby obtaining a second weighted trust component; and
calculating the trust level between the truster device and the trustee device in accordance with both the first weighted trust component and the second weighted trust component.

11. The method of claim 10, wherein the credibility level of the first network device is different than the credibility level of the second network device.

12. The method of claim 1, wherein the truster device and the first network device are in different federated network domains.

13. The method of claim 12, wherein the truster device gathers the first reputation-based attribute from a trust broker adapted to exchange trust information between the different federated network domains.

14. The method of claim 1, further comprising:
gathering an evidence-based attribute corresponding to the trustee device, the evidence-based attribute indicating a performance capability of the trustee device, and
wherein calculating the trust level between the truster device and the trustee device comprises calculating the trust level between the truster device and the trustee device in accordance with both the first reputation-based attribute and the evidence-based attribute.

15. The method of claim 14, wherein the performance capability indicated by the evidence-based attribute specifies a level of service reliability associated with the trustee device.

16. The method of claim 14, wherein the performance capability indicated by the evidence-based attribute specifies a level of security provided by the trustee device when performing the first service.

17. The method of claim 14, wherein the performance capability indicated by the evidence-based attribute specifies a quality of service provided by the trustee device when performing the first service.

18. The method of claim 14, wherein calculating the trust level between the truster device and the trustee device comprises:
adjusting the level of trust indicated by the first reputation-based attribute in accordance with a first weight, thereby obtaining a weighted trust level component;
adjusting the performance capability indicated by the evidence-based attribute in accordance with a second weight, thereby obtaining a weighted performance component; and
calculating the trust level between the truster device and the trustee device in accordance with at least the weighted trust component and the weighted performance component.

19. The method of claim 18, wherein the second weight is different than the first weight.

20. A truster device comprising:
a processor; and
a computer readable storage medium storing programming for execution by the processor, the programming including instructions to:
gather a first reputation-based attribute corresponding to a trustee device attempting to access or provide at least a first service in a network, wherein the first reputation-based attribute indicates a level of trust between a first network device and the trustee device;
calculate a trust level between the first network device and the trustee device in accordance with at least the first reputation-based attribute; and
authorize the trustee device to access or provide the first service in the network when the trust level between the first network device and the trustee device exceeds a first threshold.

21. A method for distributing trust information, the method comprising:
establishing a level of trust between a first network device and a trustee device at the beginning of a first period;
providing, by the first network device, a first reputation-based attribute to a first truster device during the first period, the first reputation-based attribute indicating the level of trust between the first network device and the trustee device;
updating the level of trust between the first network device and the trustee device at the beginning of a second period, thereby obtaining an updated level of trust between the first network device and the trustee device, wherein the second period occurs after the first period; and
providing, by the first network device, a second reputation-based attribute to the first truster device or a second truster device during the second period, the second reputation-based attribute indicating the updated level of trust between the first network device and the trustee device.

22. The method of claim 21, wherein the first network device and the first trustee device are peers in a federated network domain.

23. The method of claim 21, wherein the first network device and the first trustee device are in different federated network domains, and
wherein the first network device is a broker adapted to exchange trust information between the different federated network domains.

24. A first network device comprising:
a processor; and
a computer readable storage medium storing programming for execution by the processor, the programming including instructions to:
establish a level of trust between a first network device and a trustee device at the beginning of a first period;
provide a first reputation-based attribute to a first truster device during the first period, the first reputation-based attribute indicating the level of trust between the first network device and the trustee device;
update the level of trust between the first network device and the trustee device at the beginning of a second period, thereby obtaining an updated level of trust between the first network device and the trustee device, wherein the second period occurs after the first period; and
provide a second reputation-based attribute to the first truster device or a second truster device during the second period, the second reputation-based attribute indicating the updated level of trust between the first network device and the trustee device.
